(19) United States
(12) Patent Application Publication
(10) Pub. No.: US 2026/0056647 A1
(43) Pub. Date: Feb. 26, 2026

(54) CONTROL METHOD FOR CONTROLLING ELECTRONIC DEVICE, ELECTRONIC DEVICE, AND STORAGE MEDIUM

(71) Applicant: CANON KABUSHIKI KAISHA, Tokyo (JP)

(72) Inventor: JUMPEI TAKEICHI, Kanagawa (JP)

(21) Appl. No.: 19/300,393

(22) Filed: Aug. 14, 2025

(30) Foreign Application Priority Data
Aug. 21, 2024 (JP) 2024-139986

(51) Int. Cl. G06F 3/0484

(52) U.S. Cl. CPC G06F 3/0484

(57) ABSTRACT

A user is enabled to perform an operation more suitably. Each of a plurality of pieces of application software is managed in association with any of a plurality of spaces including a first space where a lock needs to be unlocked and a second space where the lock does not need to be unlocked. In a case where an application program is associated with the first space, control is performed to display a first screen for selecting a content saved in association with the first space. In a case where the application program is associated with the first space, control is performed to display on the first screen a first display item for displaying a guide regarding start of an application program associated with the second space.

### BACKGROUND

### Field of the Technology

The present disclosure relates to a control method for controlling an electronic device, an electronic device, and a storage medium.

### Description of the Related Art

Japanese Patent Application Laid-Open No. 2009-201163 discusses a method for generating a secure polarized electronic content from an electronic content. An electronic content includes a data portion and a format portion. In this method, a secured polarization engine selects a polarization scheme, and the secured polarization engine identifies a system resource. The system resource can be used by an interpretation application to interpret the electronic content into presentation data that can be processed by an output apparatus. The secured polarization engine determines a parameter of the system resource to be converted by the polarization scheme. The secured polarization engine makes a digital work polarized according to the polarization scheme for converting the data portion of the electronic content into a polarized data portion, thereby generating a secure polarized electronic content. The secure polarized electronic content includes the polarized data portion and the format portion and also saves the structure of the digital work, whereby the polarized digital work can be interpreted by the interpretation application.

“Function of Android 15 and Overview of API”, [searched on Jul. 30, 2024], the Internet <URL: https://developer.android.com/about/versions/15/features#private-space> discusses a private space where a user can create another space on a device and save a highly confidential app using an additional authentication layer, regarding Android 15, which is an operating system (OS) of a smartphone.

### SUMMARY

Embodiments of the present disclosure are directed to, in a mechanism for managing an app and a content in association with any of a plurality of spaces, enabling a user to operate the app and the content more suitably.

According to embodiments of the present disclosure, a non-transitory computer-readable storage medium stores an application program including instructions, which when executed by one or more processors of an electronic device, in which each of a plurality of pieces of application software is managed in association with any of a plurality of spaces including a first space where a lock needs to be unlocked and a second space where the lock does not need to be unlocked, cause the electronic device to, in a case where the application program is associated with the first space, perform control to display a first screen for selecting a content saved in association with the first space; and, in a case where the application program is associated with the first space, perform control to display on the first screen a first display item for displaying a guide regarding start of an application program associated with the second space.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an information processing system according to an exemplary embodiment of the present disclosure.

FIG. 2 is a diagram illustrating an example of a configuration of an electronic device in FIG. 1.

FIG. 3 is a diagram for describing application programs and contents saved in the electronic device.

FIG. 4 is a diagram illustrating an example of a screen displayed on a display section of the electronic device.

FIGS. 5A and 5B are a flowchart illustrating a control method for controlling the electronic device.

FIG. 6 is a diagram illustrating an example of a home screen.

FIG. 7 is a diagram illustrating an example of a file selection screen.

FIG. 8 is a diagram illustrating an example of a display item.

FIG. 9 is a diagram illustrating an example of a folder selection screen.

FIGS. 10A and 10B are diagrams illustrating examples of folder selection screens.

FIGS. 11A and 11B are diagrams illustrating examples of guides.

FIG. 12 is a diagram illustrating an example of a processing result screen.

FIG. 13 is a flowchart illustrating details of a photograph selection process in FIGS. 5A and 5B.

FIG. 14 is a diagram illustrating an example of an image list screen.

FIG. 15 is a diagram illustrating an example of an album selection screen.

FIG. 16 is a diagram illustrating an example of an image list screen.

FIG. 17 is a flowchart illustrating details of a file sharing process in FIGS. 5A and 5B.

FIG. 18 is a diagram illustrating an example of an app selection screen.

FIG. 19 is a diagram illustrating an example of a guide.

FIG. 20 is a diagram illustrating an example of an app selection screen.

### DESCRIPTION OF THE EMBODIMENTS

In Android 15, a private space can be created in addition to a personal space. However, between the personal space and the private space, a content and an app cannot be confirmed across the spaces, except for some apps and functions. Thus, it is difficult for a user to find a desired content or app. A similar issue arises not only in the personal space and the private space in Android 15, but also in a mechanism for managing an app and a content in association with separated areas (spaces) in which confirmation is not allowed from at least one area to another area without authentication.

Embodiments of the present disclosure will be described below with reference to the drawings. The following exemplary embodiments do not limit the appended claims, and not all the combinations of the features described in the exemplary embodiments are essential for a method for solving the issues in the present disclosure. In the present exemplary embodiment, if an application program is started in a private space or a personal space, and even if a desired content or app is present in a space different from the space where the application program is started, a user is assisted to select the desired content or app. Hereinafter, application software or an application program is abbreviated as an “application” or an “app”.

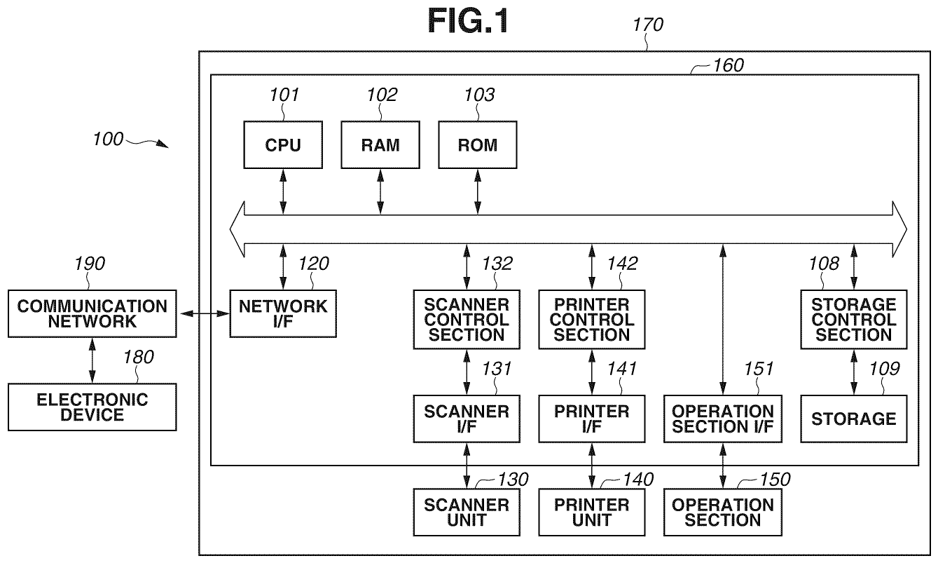

FIG. 1 is a diagram illustrating an example of the configuration of an information processing system 100 according to an exemplary embodiment of the present disclosure. The information processing system 100 includes an image forming apparatus 170, an electronic device 180, and a communication network 190.

For example, the image forming apparatus 170 is a multifunction peripheral (MFP) having a plurality of functions such as a scanner function, a print function, a copy function, and a communication function with an external apparatus. The image forming apparatus 170 may be a printer instead of an MFP.

For example, the electronic device 180 is a smartphone. The electronic device 180 is not limited to a smartphone, and may be a tablet or a personal computer. The electronic device 180 only needs to be a device that can be caused to operate by installing an application program.

The electronic device 180 and the image forming apparatus 170 can communicate with each other via the communication network 190. The electronic device 180 can transmit a print job or a scan job to the image forming apparatus 170 via the communication network 190. The image forming apparatus 170 can receive a print job or a scan job and execute printing or scanning.

The image forming apparatus 170 includes a scanner unit 130, a printer unit 140, an operation section 150, and a controller section 160. The controller section 160 includes a central processing unit (CPU) 101, a random-access memory (RAM) 102, a read-only memory (ROM) 103, a storage control section 108, storage 109, and a network interface (I/F) 120. Further, the controller section 160 includes a scanner I/F 131, a scanner control section 132, a printer I/F 141, a printer control section 142, and an operation section I/F 151.

The CPU 101 executes a software program stored in the RAM 102 and controls the entirety of the image forming apparatus 170.

For example, the ROM 103 stores a program and a fixed parameter regarding the start of the controller section 160.

The RAM 102 is used to store a program and temporary data when the CPU 101 controls the image forming apparatus 170. The program and the temporary data stored in the RAM 102 are read from the ROM 103 or the storage 109.

When a scanner process is performed via the scanner I/F 131, the scanner control section 132 receives setting information set by a user through communication with the CPU 101 and controls the operation of the scanner unit 130 based on the setting information.

When a print process is performed via the printer I/F 141, the printer control section 142 receives setting information set by the user through communication with the CPU 101 and controls the operation of the printer unit 140 based on the setting information.

The operation section I/F 151 is an interface with the operation section 150 including a liquid crystal display device unit on which a touch panel operation can be performed. The CPU 101 executes an operating system (OS) and an application program, thereby generating screen display image data that is to be displayed on the operation section 150, and outputting the screen display image data from the operation section I/F 151 to the operation section 150. The CPU 101 also executes the OS and the application program, thereby acquiring information input as a user operation from the operation section 150 via the operation section I/F 151.

The storage 109 as main storage stores a program executed by the CPU 101, a program management table, and various pieces of data, and is controlled to transmit and receive data by the storage control section 108. The storage 109 can also reserve a print job. The program executed by the CPU 101 is a boot program executed by the CPU 101 to start the OS when the image forming apparatus 170 starts. In a case where a print job is reserved, print information such as the number of images, a color/monochrome type, one-sided/two-sided, and enlargement/reduction is stored. If the user reserves a print job and then gives an instruction to perform printing, printing is executed. Examples of the storage 109 include a hard disk drive (HDD), a solid-state drive (SSD), an embedded MultiMediaCard (eMMC), a NOT AND (NAND) flash memory, and a NOT OR (NOR) flash memory.

The network I/F 120 transmits and receives data to and from the communication network 190. The network I/F 120 receives data sent from the communication network 190 and transmits image data read by the scanner unit 130 or image data saved in the storage 109 to the electronic device 180 via the communication network 190.

According to a scan instruction based on an operation on the operation section 150 or a scan job received from the electronic device 180, the CPU 101 controls the scanner unit 130. The scanner unit 130 reads an original document and generates binary monochrome or multivalued color image data.

According to an operation on the operation section 150 or a print job received from the electronic device 180, the CPU 101 controls the printer unit 140. The printer unit 140 prints image data generated by the scanner unit 130 or print data received from the electronic device 180 on a print sheet.

The operation section 150 includes a display section (a liquid crystal display) that displays the state of the image forming apparatus 170 to the user, and an input mechanism such as a button and/or a touch panel that receives an input and an output to the image forming apparatus 170 provided by the user.

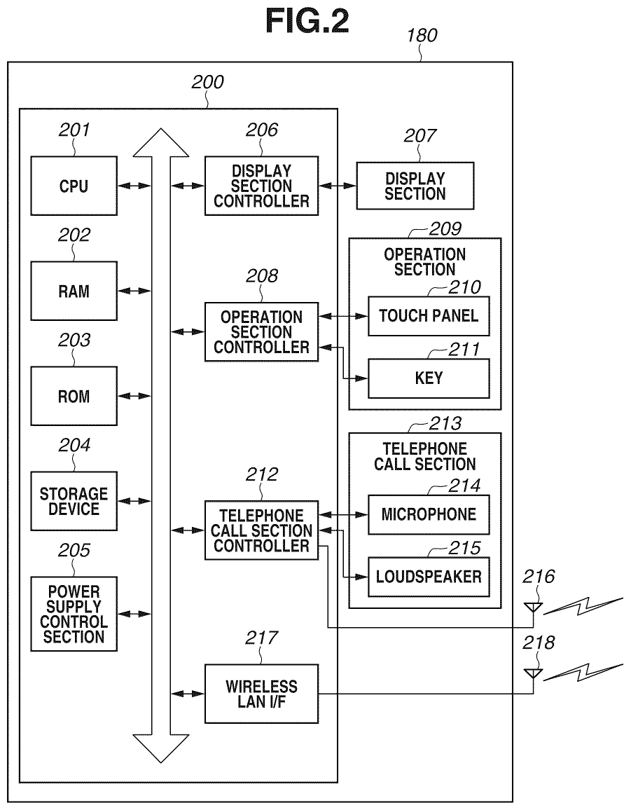

FIG. 2 is a diagram illustrating an example of the configuration of the electronic device 180 in FIG. 1. For example, the electronic device 180 is a smartphone. The electronic device 180 includes a controller section 200, a display section 207, an operation section 209, a telephone call section 213, a sound antenna 216, and a wireless local area network (LAN) antenna 218.

The controller section 200 includes a CPU 201, a RAM 202, a ROM 203, a storage device 204, a power supply control section 205, a display section controller 206, an operation section controller 208, a telephone call section controller 212, and a wireless LAN I/F 217. The operation section 209 includes a touch panel 210 and a key 211. The telephone call section 213 includes a microphone 214 and a loudspeaker 215.

The CPU 201 is a central processing unit that controls the entirety of the electronic device 180.

The RAM 202 is a work memory for the CPU 201 to operate, and is used to load various programs and save the result of a calculation process.

The ROM 203 is a memory that saves a startup program for the CPU 201 and various pieces of setting information regarding the CPU 201.

The storage device 204 is a non-volatile memory that saves a large-sized program and data, and is a flash memory or an HDD inside the controller section 200.

The power supply control section 205 controls power required for the electronic device 180 to operate, and therefore is composed of a battery and a charging module for the battery.

The display section controller 206 transmits image data to the display section 207 in compliance with a communication protocol for the display section 207.

The operation section controller 208 receives an input from the touch panel 210 and the key 211 and converts the input into data that can be interpreted by the CPU 201. The touch panel 210 and the display section 207 are integrally formed, and the touch panel 210 can detect a touch operation performed on a display surface of the display section 207.

The telephone call section controller 212 performs a process for converting a sound signal received from the microphone 214 into a radio wave to be transmitted to an opposing device and outputting the radio wave to the sound antenna 216, or converting a radio wave received from the opposing device by the sound antenna 216 into a sound and outputting the sound to the loudspeaker 215.

The wireless LAN I/F 217 transmits and receives data to and from the communication network 190 via the wireless LAN antenna 218.

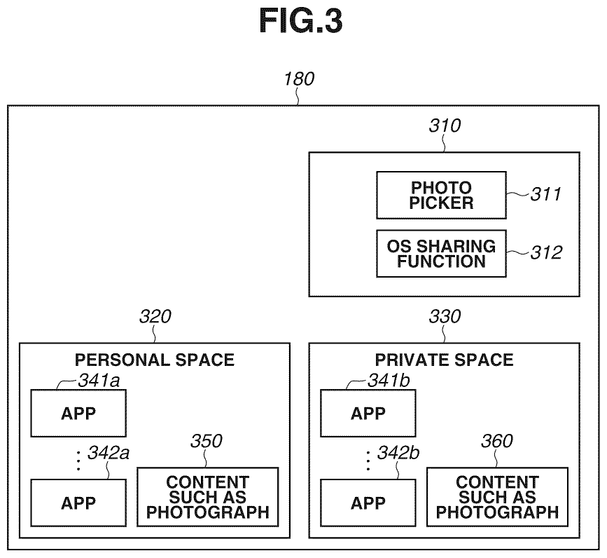

FIG. 3 is a diagram for describing application programs and contents saved in the electronic device 180. The electronic device 180 includes an OS standard function 310, a personal space 320, and a private space 330.

For example, an OS of the electronic device 180 is Android 15. In Android 15, the user can create the private space 330 in addition to the personal space 320 on the electronic device 180. The private space 330 can save highly confidential apps 341b and 342b using a lock function.

The personal space 320 saves an app 341a, an app 342a, and a content 350. In other words, the app 341a, the app 342a, and the content 350 are recorded in association with the personal space 320, which is a virtual space. More specifically, data of the app 341a, the app 342a, and the content 350 is recorded in the hierarchy of a first directory corresponding to the personal space 320. For example, the content 350 is a photograph file (an image file) or a document file and is a content that can be used by the app 341a or 342a.

The private space 330 saves the app 341b, the app 342b, and a content 360 such as a photograph. In other words, the app 341b, the app 342b, and the content 360 such as a photograph are recorded in association with the private space 330, which is a virtual space. More specifically, data of the app 341b, the app 342b, and the content 360 is recorded in the hierarchy of a second directory corresponding to the private space 330. For example, the content 360 is a photograph file or a document file and is a content that can be used by the app 341b or 342b. The personal space 320 and the private space 330 are spaces virtually separated from each other. The first and second directories are different directories and do not have a hierarchical relationship with each other.

The apps 341a and 341b are the same apps as each other. The apps 342a and 342b are the same apps as each other. If there is an app that the user wishes to use in both the personal space 320 and the private space 330, it is necessary to install the app in both the personal space 320 and the private space 330 (record the app in association with both the personal space 320 and the private space 330).

If the app 341a or 342a is started in the personal space 320, the app 341a or 342a can refer to the content 350, but cannot refer to the content 360 in the private space 330 unless the OS standard function 310 is used. Even if the OS standard function 310 is used, the app 341a or 342a cannot refer to the content 360 in the private space 330 unless the lock of the private space 330 is unlocked.

Similarly, if the app 341b or 342b is started in the private space 330, the app 341b or 342b can refer to the content 360, but cannot refer to the content 350 in the personal space 320 unless the OS standard function 310 is used.

The apps 341b and 342b and the content 360 in the private space 330 can be locked, and cannot be used without unlocking the lock by authentication.

For example, the OS standard function 310 includes a photo picker 311 and an OS sharing function 312. If the lock of the private space 330 is unlocked, the photo picker 311 can refer to the content 350 in the personal space 320 and the content 360 in the private space 330. If the lock of the private space 330 is unlocked, the OS sharing function 312 can refer to the apps 341a and 342a in the personal space 320 and the apps 341b and 342b in the private space 330.

The photo picker 311 is a photograph selection tool for selecting a photograph as the content 350 or 360. The OS sharing function 312 is the function of selecting an app as a sharer that shares a content such as an image.

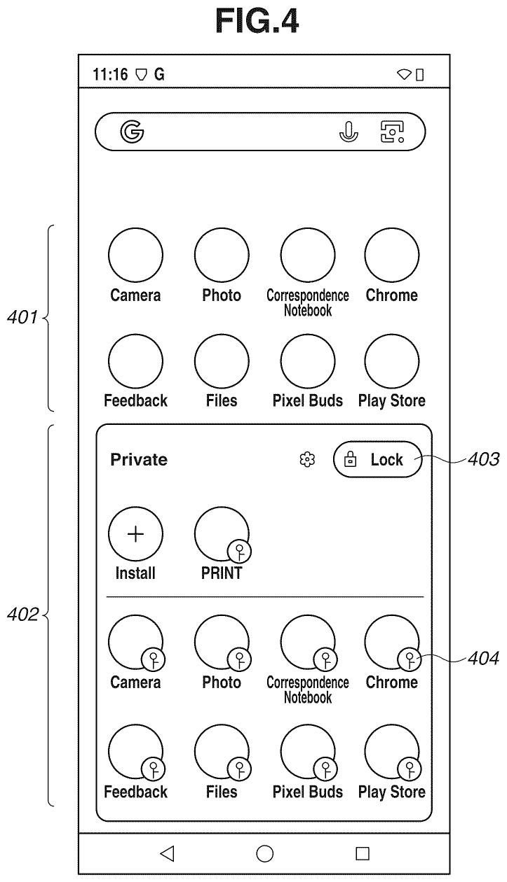

FIG. 4 is a diagram illustrating an example of a screen displayed on the display section 207 of the electronic device 180. A display area 401 displays startup icons (launchers) for the apps 341a and 342a installed in the personal space 320. A display area 402 displays startup icons for the apps 341b and 342b installed in the private space 330. The startup icons for the apps 341b and 342b installed in the private space 330 and the startup icons for the apps 341a and 342a installed in the personal space 320 are displayed in the display areas 401 and 402 of the electronic device 180 different from each other even if the apps 341b and 342b and the apps 341a and 342a are the same apps. The display area 402 is in a display form in which the display area 402 is separated such that the outer frame of the display area 402 is surrounded by a line, and is in a display form in which the user can recognize that the display area 402 is an area visually different (a zone divided) from the display area 401. The display area 402 only needs to be in a display form in which it can be identified that the display area 402 is an area separated from the display area 401. The separation of the display area 402 may be indicated in another display form, for example, by differentiating the color or the design of the background of the display area 402 from the background of the display area 401, or separating the display area 402 by a dotted line.

The electronic device 180 can be used by unlocking a first lock. For example, the first lock is a lock on a lock screen displayed when the electronic device 180 is returned from a power-off or sleep state, or when the display section 207 is returned from a display state. A home screen is displayed by unlocking the first lock. The private space 330 requires the unlocking of a second lock 403 different from the unlocking of the first lock in at least one of a timing and a lock unlocking key. To use the private space 330, it is necessary to display the home screen by unlocking the first lock and then further unlock the second lock 403. The personal space 320 does not have a lock different from the first lock, and is basically a space that can be used so long as the home screen is displayed. An app can also be individually locked (a third lock). To use an individually locked app, it is necessary to unlock the app (unlock the third lock) even if the app is in the personal space 320.

In the private space 330, if the second lock 403 is locked, the display area 402 is minimized, and none of app icons (startup icons) corresponding to apps present in the private space 330 is displayed, thereby preventing the apps present in the private space 330 from being started. In this state, the user cannot view what apps are present in the private space 330. If the user touches the second lock 403 displayed in the minimized display area 402, an authentication screen is displayed. The user inputs authentication information for unlocking the second lock 403, whereby the second lock 403 is unlocked. As a method for authenticating the second lock 403, passcode authentication, pattern authentication, fingerprint authentication, or face authentication can be used. The authentication information is a passcode, the trajectory pattern of a touch input, a fingerprint, or a captured face image. If the authentication is successful and the second lock 403 is unlocked, the display range of the display area 402 is expanded, and the app icons (the startup icons) corresponding to the apps present in the private space 330 are displayed. In each startup icon displayed in the display area 402, a key mark 404 that is a mark indicating an app present in the private space 330 is displayed so that it can be identified that the app is managed differently from an app present in the personal space 320.

The private space 330 and the personal space 320 are different from each other in the root directory of the save destination of a content and an app. The root directory of the save destination of a content and an app in the personal space 320 is “storage/emulated/0”. The root directory of the save destination of a content and an app in the private space 330 is a directory other than “storage/emulated/0” and is a directory having a number at or after “storage/emulated/10”.

If the user performs an operation for creating a private space 330 in the state where a single personal space 320 is present, the private space 330 is created. The root directory of the created private space 330 is “storage/emulated/10”.

In a case where an app is to be used in each of the private space 330 and the personal space 320, the app needs to be installed in each of the private space 330 and the personal space 320 even if the app is the same app, except for the OS standard function 310.

In a case where the lock of the second lock 403 is not unlocked, an app installed in the private space 330 is hidden in the most recent view, a notification, a setting, and another app.

The apps 341a and 342a and the content 350 in the personal space 320 cannot be moved to the private space 330 by a user operation.

However, between the personal space 320 and the private space 330, a content and an app cannot be referred to across the spaces, except for the OS standard function 310. Thus, it is difficult for the user to find a desired content or app.

One of the purposes of the present exemplary embodiment is as follows. If an app is started in the private space 330 or the personal space 320, there is a case where a desired content is present in a space different from the space where the app is started. Thus, a guide for starting the app in another space is enabled to be displayed.

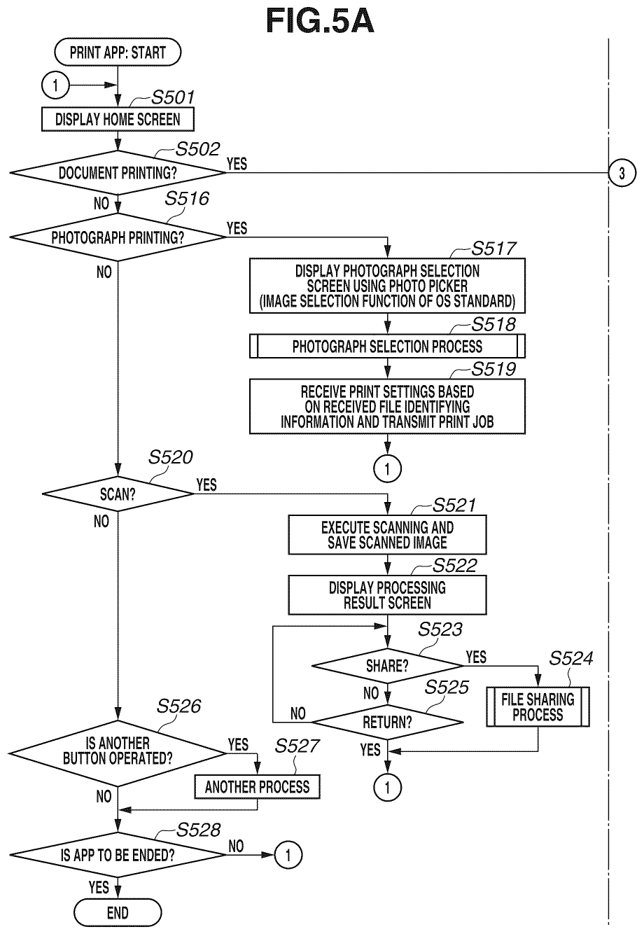

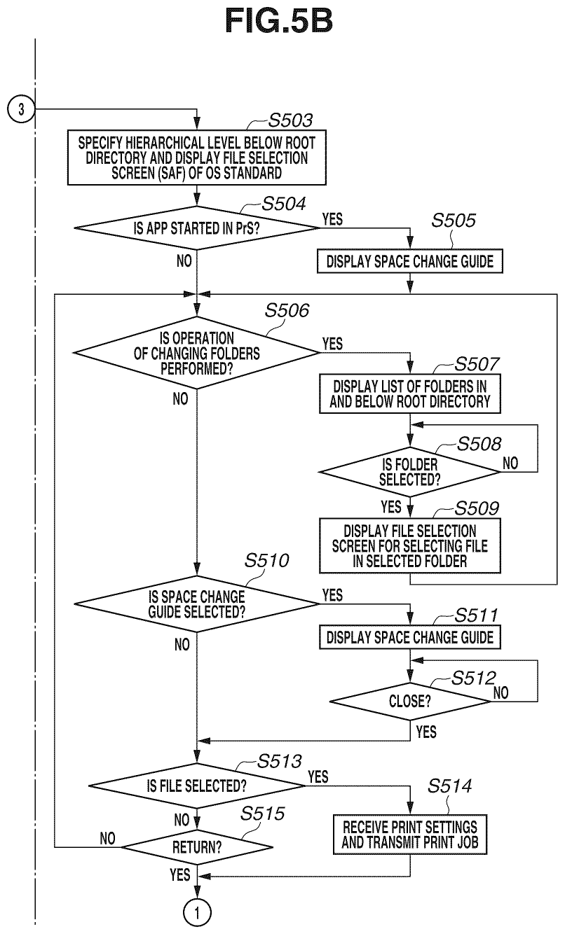

FIGS. 5A and 5B are a flowchart illustrating a control method for controlling the electronic device 180. The processing of the flowchart in FIGS. 5A and 5B is achieved by the CPU 201 loading a print app recorded in the storage device 204 into the RAM 202 and executing the print app. FIGS. 5A and 5B illustrate processing by the execution of the print app installed in the personal space 320 or the private space 330. The print app is an app for communicating with the image forming apparatus 170 and is an app that operates on the electronic device 180.

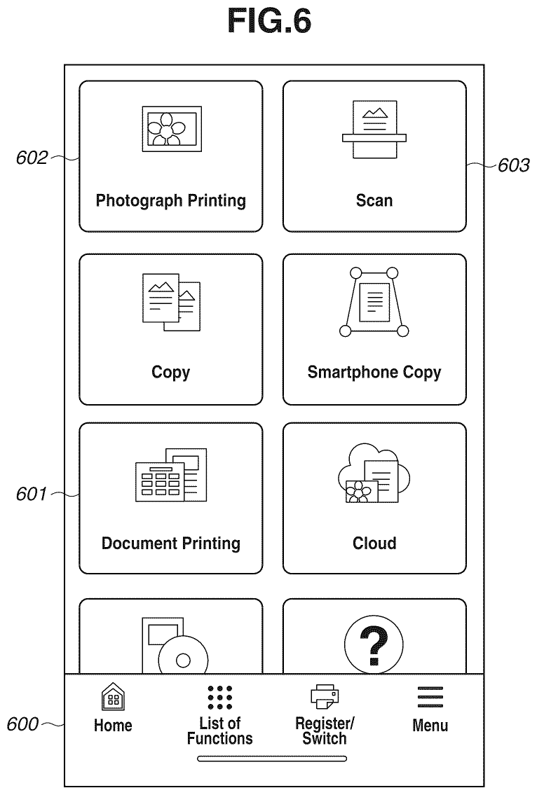

In step S501, the CPU 201 performs control to display a home screen 600 in FIG. 6 on the display section 207. On the home screen 600, document printing 601, photograph printing 602, or scan 603 can be selected by a user operation on the touch panel 210.

In step S502, the CPU 201 determines whether the document printing 601 on the home screen 600 is subjected to a touch operation and thereby selected by a user operation on the touch panel 210. If the document printing 601 is subjected to a touch operation (Yes in step S502), the processing proceeds to step S503. If the document printing 601 is not subjected to a touch operation (No in step S502), the processing proceeds to step S516.

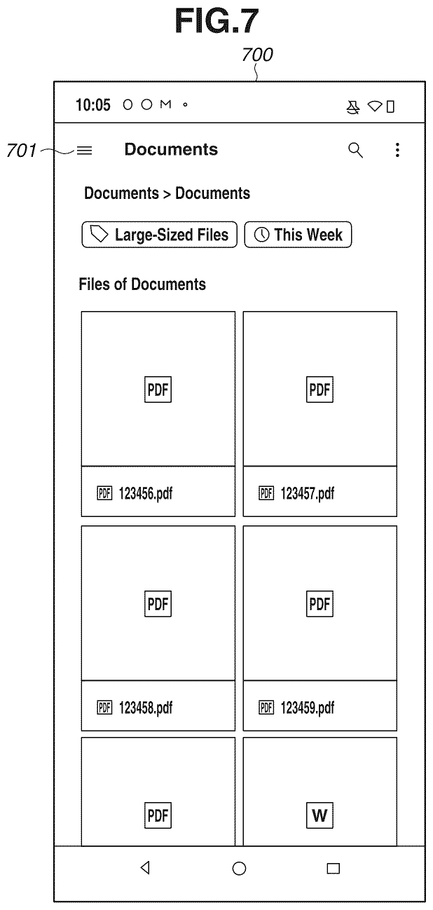

In step S503, using a file selection function (the Storage Access Framework (SAF)) of the OS standard function 310, the CPU 201 specifies a hierarchical level below the root directory of the space to which the started print app belongs, and performs control to display a file selection screen 700 in FIG. 7 on the display section 207. Specifically, the CPU 201 functions as a control section and performs control to display on the display section 207 the file selection screen 700 for selecting a document file (a content) saved in the electronic device 180. The file selection screen 700 is an example of a content selection screen and is a screen for selecting a document file such as a Portable Document Format (PDF) file or a Word file as a printing target by a user operation on the touch panel

### 210.

If the print app in the personal space 320 is started, the root directory of the personal space 320 is “storage/emulated/0”. If the print app in the private space 330 is started, the root directory of the private space 330 is “storage/emulated/10”, for example.

In step S504, the CPU 201 determines whether the print app is started in the private space (PrS) 330. If the print app is started in the private space 330 (Yes in step S504), the processing proceeds to step S505. If the print app is started in the personal space 320 (No in step S504), the processing proceeds to step S506.

Two determination methods in step S504 are described. First, a first determination method is described. If the storage locations of document files (contents) referred to when the file selection screen 700 in step S503 is displayed satisfy a predetermined condition, the CPU 201 determines that the print app is started in the private space 330.

Specifically, if the storage locations of the document files (the contents) referred to when the file selection screen 700 in step S503 is displayed are “storage/emulated/0”, the CPU 201 determines that the print app is started in the personal space 320. If the storage locations of the document files (the contents) referred to when the file selection screen 700 in step S503 is displayed are a directory other than “storage/emulated/0”, the CPU 201 determines that the print app is started in the private space 330.

In Android 15, the root directory of the personal space 320 is “storage/emulated/0”. If the user performs an operation for creating a private space 330, the private space 330 is created. The root directory of the created private space 330 is “storage/emulated/10”.

Next, a second determination method is described. The second determination method is a method for acquiring information regarding a user type from the OS and making a determination based on the acquired user type. For example, there is a case where information such as USER_TYPE_PROFILE_PRIVATE is acquired as information regarding the current user type from the OS using an application programming interface (API). If this information is acquired, it can be determined that the current user is a user of the private space 330 (the currently started app is an app in the private space 330).

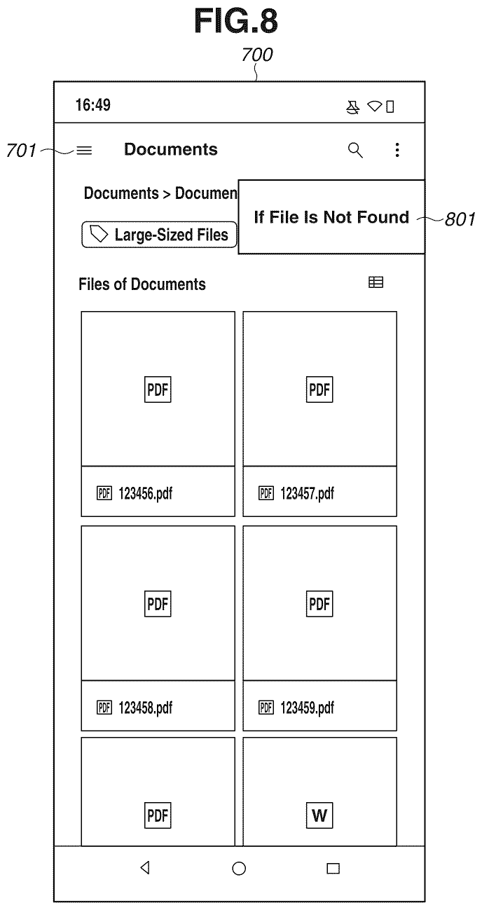

In step S505, the CPU 201 functions as a control section and performs control to display a display item 801 on the file selection screen 700 as illustrated in FIG. 8. The display item 801 indicates “if file is not found”. The display item 801 is a display item for guiding the user through a method for enabling the selection of a file (a content) present in a space different from the space where the print app is started. The specific content of the display item 801 is a content regarding a method for starting the print app in the personal space 320 or switching the private space 330 and the personal space 320 as a selection target. The display item 801 is a button on which a touch operation can be performed, but a guide may be displayed in the display item 801 itself.

The CPU 201 can perform control to display in the display item 801 a display content regarding a case where a document file that the user wishes to select is not displayed on the file selection screen 700, or a case where the user wishes to display a document file as another selection candidate.

If the print app is started in the private space 330, the file selection screen 700 only displays document files in the private space 330 and does not display document files in the personal space 320. Thus, the user cannot select a document file in the personal space 320 on the file selection screen 700. Accordingly, in step S505, if the print app is started in the private space 330, there is a case where a desired document file is present in the personal space 320 different from the private space 330 where the print app is started. Thus, the CPU 201 displays the display item 801. Then, the processing proceeds to step S506.

If the print app is started in the personal space 320, the CPU 201 performs control not to display a display item for displaying a guide regarding the start of the print app in the private space 330.

In step S506, the CPU 201 determines whether a user operation of changing folders is performed using a menu 701 on the file selection screen 700. If the user operation of changing folders is performed (Yes in step S506), the processing proceeds to step S507. If the user operation of changing folders is not performed (No in step S506), the processing proceeds to step S510.

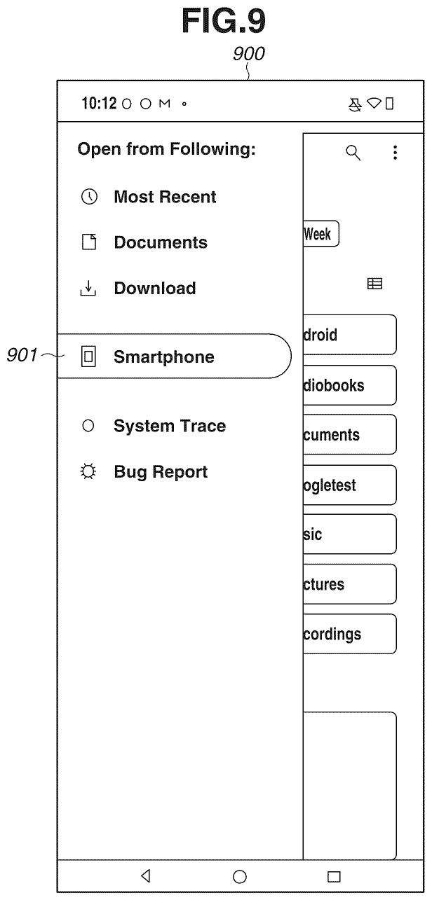

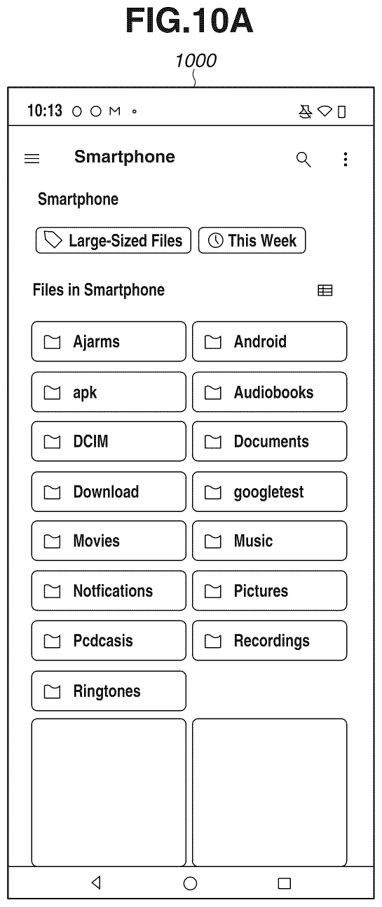

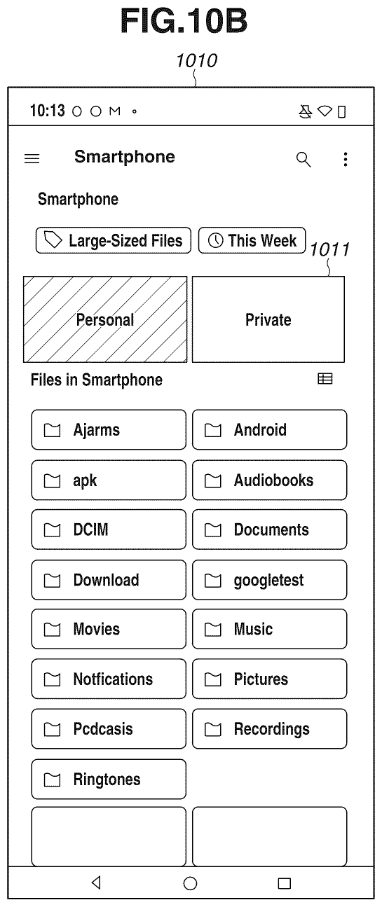

In step S507, the CPU 201 performs control to display a folder selection screen 900 in FIG. 9 on the display section 207. Then, if a “smartphone” folder 901 is selected on the folder selection screen 900, and if the lock of the second lock 403 is not unlocked (the private space 330 is locked), the CPU 201 performs control to display a folder selection screen 1000 in FIG. 10A on the display section 207. The folder selection screen 1000 is a screen that allows the selection of all folders in and below the root directory of the space to which the started print app belongs in the electronic device 180. If the lock of the second lock 403 is unlocked, the CPU 201 performs control to display a folder selection screen 1010 in FIG. 10B on the display section 207. The folder selection screen 1010 displayed immediately after the “smartphone” folder 901 is operated displays in a selectable manner all the folders in and below the root directory to which the started print app belongs in the electronic device 180. The folder selection screen 1010 also displays a switching item 1011 that receives an instruction to switch the personal space 320 and the private space 330. By a touch operation on the switching item 1011, it is possible to switch the space to which the folders displayed on the folder selection screen 1010 belong. For example, if the private space 330 is switched to the personal space 320, the display switches from a list of folders in the private space 330 to a list of folders in the personal space 320. That is, the folder selection screen 1010 is a screen that allows the selection of all the folders in and below the root directory of the space selected using the switching item 1011 in the electronic device 180. If another option other than the “smartphone” folder 901 is selected in FIG. 9, files according to the selection are displayed.

In step S508, the CPU 201 determines whether a folder is selected on the folder selection screen 1000. If a folder is selected (Yes in step S508), the processing proceeds to step S509. If a folder is not selected (No in step S508), the processing returns to step S508.

In step S509, the CPU 201 performs control to display on the display section 207 the file selection screen 700 for selecting a file in the folder selected in step S508 as illustrated in FIG. 7. Then, the processing returns to step S506.

In step S510, the CPU 201 determines whether the display item 801 in FIG. 8 is subjected to a touch operation (selected) by a user operation on the touch panel 210. If the display item 801 is subjected to a touch operation (Yes in step S510), the processing proceeds to step S511. If the display item 801 is not subjected to a touch operation (No in step S510), the processing proceeds to step S513.

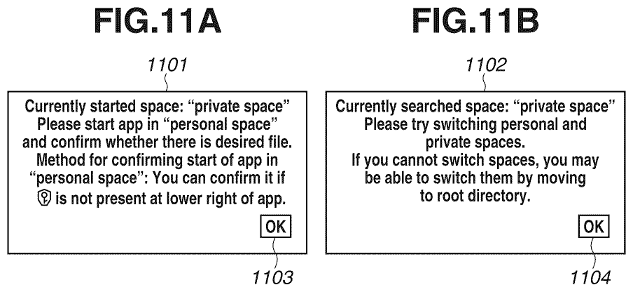

In step S511, the CPU 201 performs control to display a guide 1101 in FIG. 11A or a guide 1102 in FIG. 11B on the display section 207. The guide 1101 is a guide that urges the user to start the print app belonging to the personal space 320 although the print app belonging to the private space 330 is currently started. The guide 1102 is a guide that recommends switching the private space 330 and the personal space 320. FIG. 11B illustrates a guide for displaying a screen for selecting a content saved in association with the personal space 320 even in a case where the print app is started in the private space 330. Particularly, a message “you may be able to switch spaces by moving to root directory” included in FIG. 11B is a guide indicating an operation method for displaying a screen that enables the switching of target spaces (the folder selection screen 1010 including the switching item 1011) so that a content saved in association with the personal space 320 is a selection target.

As described above, only if the print app is started in the private space 330, the display item 801 in FIG. 8 is displayed, and the guide 1101 in FIG. 11A or the guide 1102 in FIG. 11B is displayed. Thus, if the print app is started in the personal space 320, the display item 801 in FIG. 8 is not displayed, and neither the guide 1101 in FIG. 11A nor the guide 1102 in FIG. 11B is displayed.

In step S512, the CPU 201 determines whether an “OK” button 1103 in FIG. 11A or an “OK” button 1104 in FIG. 11B is subjected to a touch operation. If the “OK” button 1103 or 1104 is subjected to a touch operation (Yes in step S512), the CPU 201 ends the display of (hides) the guide 1101 or 1102, and the processing proceeds to step S513. If the “OK” button 1103 or 1104 is not subjected to a touch operation (No in step S512), the processing returns to step S512.

In step S513, the CPU 201 determines whether any of the document files is selected on the file selection screen 700. If any of the document files is selected (Yes in step S513), the processing proceeds to step S514. If none of the document file is selected (No in step S513), the processing proceeds to step S515.

In step S514, the CPU 201 receives the print settings of the document file selected in step S513 and performs control to transmit a print job for the document file selected in step S513 to the image forming apparatus 170 (a printer). Then, the processing returns to step S501.

In step S515, the CPU 201 determines whether a “return” button on the file selection screen 700 is subjected to a touch operation by a user operation on the touch panel 210. If the “return” button is not subjected to a touch operation (No in step S515), the processing returns to step S506. If the “return” button is subjected to a touch operation (Yes in step S515), the processing returns to step S501.

Although a description has been given using as an example a case where in steps S504 and S505, if the print app is started in the private space 330, the CPU 201 displays the display item 801 in FIG. 8, the present disclosure is not limited to this. Also if the print app is started in the personal space 320, the CPU 201 may perform control to display a display item for displaying a guide regarding by the start of the print app in the private space 330. In this case, if the display item is subjected to a touch operation, the CPU 201 performs control to display the guide regarding the start of the print app in the private space 330.

In step S516, the CPU 201 determines whether the photograph printing 602 on the home screen 600 in FIG. 6 is subjected to a touch operation and thereby selected by a user operation on the touch panel 210. If the photograph printing 602 is subjected to a touch operation (Yes in step S516), the processing proceeds to step S517. If the photograph printing 602 is not subjected to a touch operation (No in step S516), the processing proceeds to step S520.

In step S517, the CPU 201 performs control to display a photograph selection screen using the photo picker 311 of the OS standard function 310.

In steps S502 and S503, the file selection screen 700 (the SAF) is used in the case of the document printing. In contrast, in steps S516 and S517, the photo picker 311 is used in the case of the photograph printing.

First, the reason for using the photo picker 311 in the case of the photograph printing is described. This is because the photo picker 311 obtains few permissions in advance from the user. If the print app displays a screen for selecting an image file without using the photo picker 311, the selection screen needs to receive an operation of permitting the display of an image file from an individual user with respect to each image file, and therefore, an image file of a newly captured photograph is not displayed on the selection screen. The SAF does not need to obtain a permission in advance, but only enables an image file to be confirmed with respect to each folder, and therefore has poor listing properties. Thus, the SAF has trouble with the operability of image selection. In contrast, the photo picker 311 displays photographs (image files) as selection candidates in a list without obtaining a permission in advance from the user, and therefore facilitates the selection of an intended photograph.

Next, the reason for using the file selection screen 700 (the SAF) in the case of the document printing is described. This is because only an image file is a selection target in the photo picker 311, and the photo picker 311 cannot display document files as options.

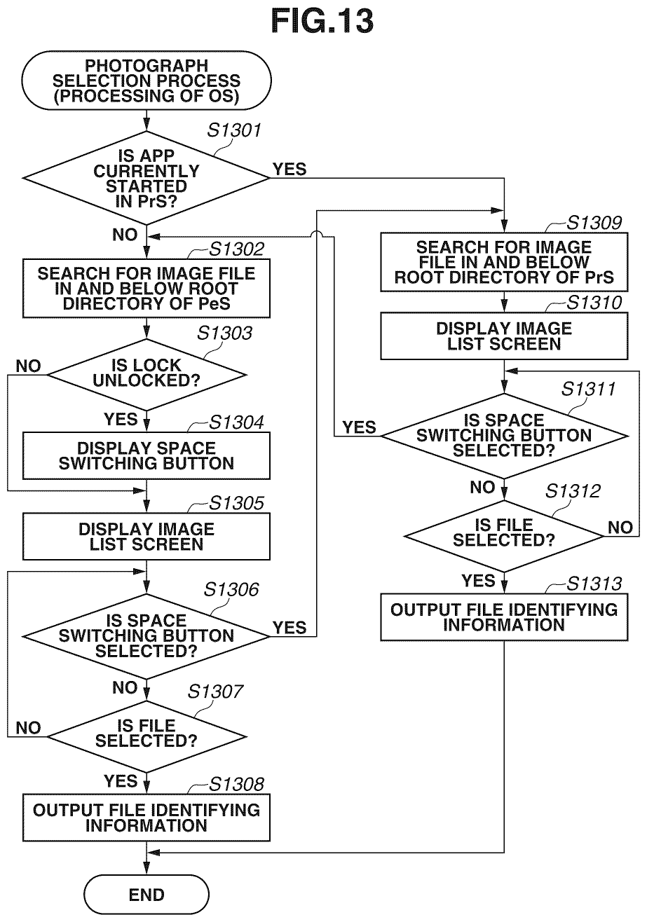

In step S518, the CPU 201 performs a photograph selection process and receives file identifying information. The details of the process of step S518 will be described below with reference to FIG. 13.

In step S519, the CPU 201 receives the print settings of a photograph file (an image file) based on the file identifying information in step S518 and transmits a print job for the selected photograph file to the image forming apparatus 170. Then, the processing returns to step S501.

In step S520, the CPU 201 determines whether the scan 603 on the home screen 600 in FIG. 6 is subjected to a touch operation and thereby selected by a user operation on the touch panel 210. If the scan 603 is subjected to a touch operation (Yes in step S520), the processing proceeds to step S521. If the scan 603 is not subjected to a touch operation (No in step S520), the processing proceeds to step S526.

In step S521, the CPU 201 transmits a scan job to the image forming apparatus 170 as a scanner. The image forming apparatus 170 performs scanning according to the received scan job and transmits an image obtained by the scanning to the electronic device 180. The CPU 201 of the electronic device 180 receives the image (a content) scanned by the image forming apparatus 170 from the image forming apparatus 170 and saves the received image in the storage device 204.

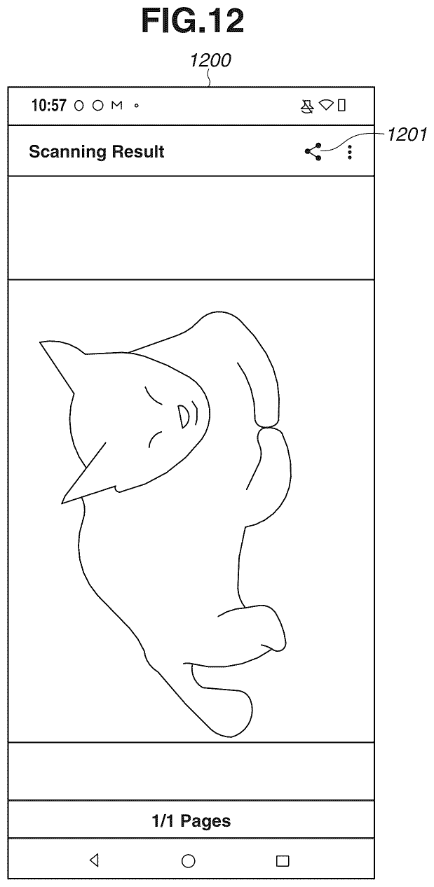

In step S522, the CPU 201 performs control to display a processing result screen 1200 for displaying the scanned image on the display section 207 as illustrated in FIG. 12.

In step S523, the CPU 201 determines whether a “share” button 1201 on the processing result screen 1200 in FIG. 12 is subjected to a touch operation and thereby selected by a user operation on the touch panel 210. If the “share” button 1201 is subjected to a touch operation (Yes in step S523), the processing proceeds to step S524. If the “share” button 1201 is not subjected to a touch operation (No in step S523), the processing proceeds to step S525.

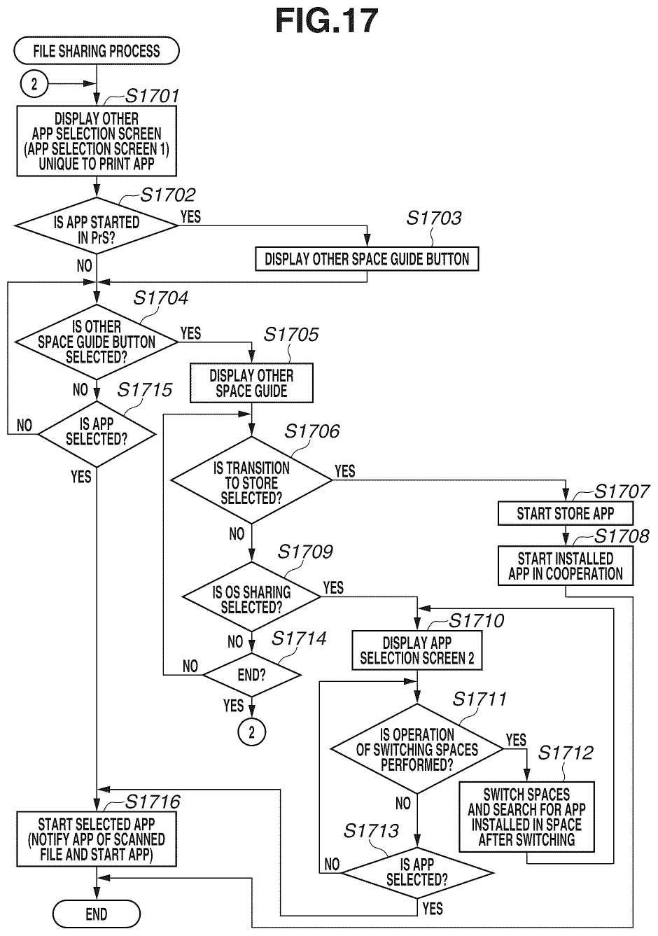

In step S524, the CPU 201 performs a file sharing process on the scanned image. The details of the process of step S524 will be described below with reference to FIG. 17.

In step S525, the CPU 201 determines whether a “return” button on the processing result screen 1200 in FIG. 12 is subjected to a touch operation by a user operation on the touch panel 210. If the “return” button is not subjected to a touch operation (No in step S525), the processing returns to step S523. If the “return” button is subjected to a touch operation (Yes in step S525), the processing returns to step S501.

In step S526, the CPU 201 determines whether another button on the home screen 600 in FIG. 6 is subjected to a touch operation by a user operation on the touch panel 210. If another button is subjected to a touch operation (Yes in step S526), the processing proceeds to step S527. If another button is not subjected to a touch operation (No in step S526), the processing proceeds to step S528.

In step S527, the CPU 201 performs a process based on another button subjected to the touch operation. Then, the processing proceeds to step S528.

In step S528, the CPU 201 determines whether an operation of ending the print app is performed by a user operation on the touch panel 210. If the operation of ending the print app is not performed (No in step S528), the processing returns to step S501. If the operation of ending the print app is performed (Yes in step S528), the CPU 201 closes the print app, and the processing of the flowchart in FIGS. 5A and 5B ends.

FIG. 13 is a flowchart illustrating the details of the photograph selection process in step S518 in FIG. 5A. The processing of the flowchart in FIG. 13 is processing using the photo picker 311.

In step S1301, the CPU 201 determines whether the print app is currently started in the private space 330. If the print app is started in the private space 330 (Yes in step S1301), the processing proceeds to step S1309. If not, i.e., if the print app is started in the personal space 320 (No in step S1301), the processing proceeds to step S1302.

In step S1302, the CPU 201 searches for an image file in and below the root directory of the personal space (PeS) 320. The root directory of the personal space (PeS) 320 is “storage/emulated/0”, for example.

In step S1303, the CPU 201 determines whether the lock of the second lock 403 of the private space 330 in FIG. 4 is unlocked.

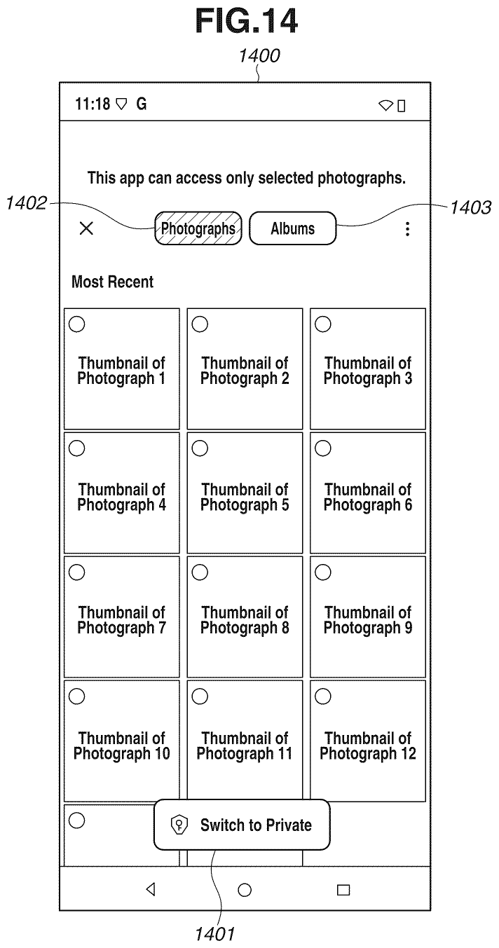

If the lock is unlocked in step S1303 (Yes in step S1303), the processing proceeds to step S1305 via step S1304. In step S1305 via step S1304, the CPU 201 performs control to display on the display section 207 an image list screen 1400 including a space switching button 1401 as illustrated in FIG. 14. The space switching button 1401 is a button for switching from an image list screen for the personal space 320 to an image list screen for the private space 330. Then, the processing proceeds to step S1306.

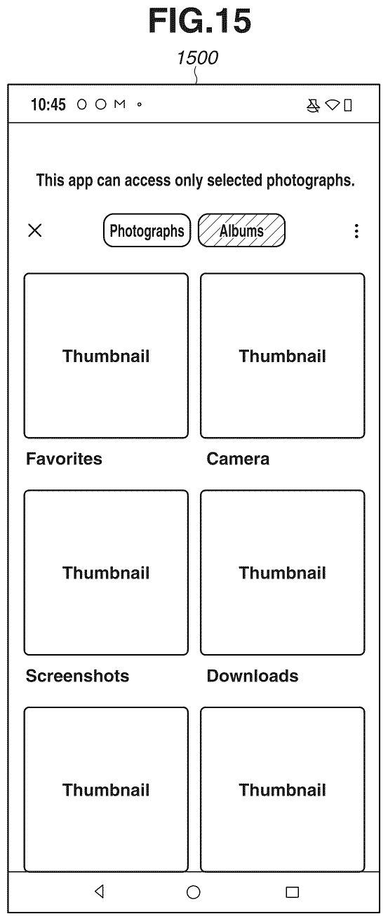

The image list screen 1400 in FIG. 14 illustrates an example of an image list screen in the state where a “photographs” button 1402 is selected. If an “albums” button 1403 is selected on the image list screen 1400, the CPU 201 performs control to display an album selection screen 1500 in FIG. 15 on the display section 207. If a desired album is selected on the album selection screen 1500, the CPU 201 displays an image selection screen for selecting an image belonging to the selected album.

If the lock is not unlocked in step S1303 (No in step S1303), the processing proceeds to step S1305 not via step S1304. In step S1305, the CPU 201 performs control to display on the display section 207 the image list screen 1400 that does not include the space switching button 1401. If the lock is not unlocked, since it is not possible to switch from the personal space 320 to the private space 330, the CPU 201 performs control not to display the space switching button 1401. Then, the processing proceeds to step S1306.

In step S1306, the CPU 201 determines whether the space switching button 1401 in FIG. 14 is subjected to a touch operation by a user operation on the touch panel 210. If the space switching button 1401 is subjected to a touch operation (Yes in step S1306), the processing proceeds to step S1309. If the space switching button 1401 is not subjected to a touch operation (No in step S1306), the processing proceeds to step S1307. If the lock of the second lock 403 is not unlocked, the determination in step S1306 is No.

In step S1307, the CPU 201 determines whether an image file is selected on the image list screen 1400 in FIG. 14. If an image file is not selected (No in step S1307), the processing returns to step S1306. If an image file is selected (Yes in step S1307), the processing proceeds to step S1308.

In step S1308, the CPU 201 saves the selected image file in a predetermined location of the storage device 204 and outputs the save location as file identifying information that is information identifying the selected image. Then, the processing of the flowchart in FIG. 13 ends.

In step S1309, the CPU 201 searches for an image file in and below the root directory of the private space (PrS) 330. The root directory of the private space (PrS) 330 is “storage/emulated/10”, for example.

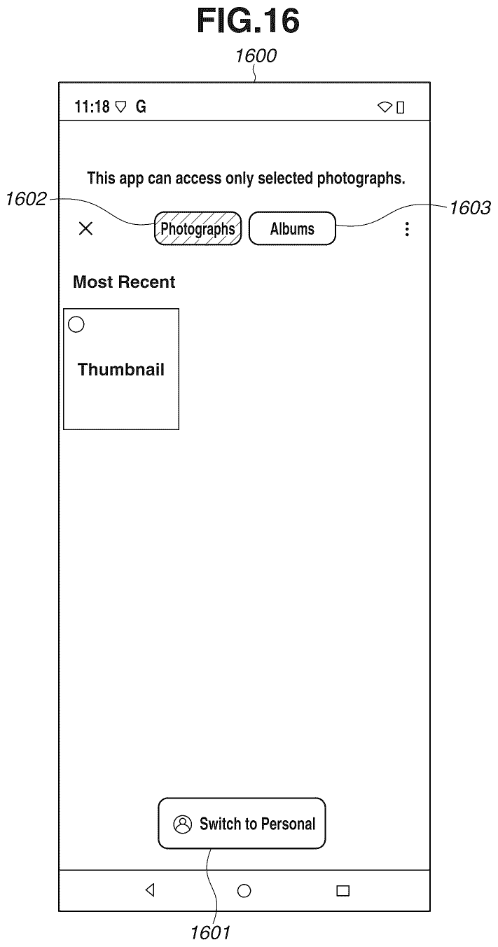

In step S1310, the CPU 201 performs control to display an image list screen 1600 including a space switching button 1601 on the display section 207 as illustrated in FIG. 16. The space switching button 1601 is a button for switching from an image list screen for the private space 330 to an image list screen for the personal space 320. Then, the processing proceeds to step S1311.

The image list screen 1600 in FIG. 16 illustrates an example of an image list screen in the state where a “photographs” button 1602 is selected. If an “albums” button 1603 is selected on the image list screen 1600, the CPU 201 performs control to display an album selection screen similar to the album selection screen 1500 in FIG. 15 on the display section 207. If a desired album is selected on the album selection screen, the CPU 201 displays an image selection screen for selecting an image belonging to the selected album.

In step S1311, the CPU 201 determines whether the space switching button 1601 in FIG. 16 is subjected to a touch operation by a user operation on the touch panel 210. If the space switching button 1601 is subjected to a touch operation (Yes in step S1311), the processing proceeds to step S1302. In step S1302, the CPU 201 performs the above process. If the space switching button 1601 is not subjected to a touch operation (No in step S1311), the processing proceeds to step S1312.

In step S1312, the CPU 201 determines whether an image file is selected on the image list screen 1600 in FIG. 16. If an image file is not selected (No in step S1312), the processing returns to step S1311. If an image file is selected (Yes in step S1312), the processing proceeds to step S1313.

In step S1313, the CPU 201 saves the selected image file in a predetermined location of the storage device 204 and outputs the save location as file identifying information that is information identifying the selected image. Then, the processing of the flowchart in FIG. 13 ends.

FIG. 17 is a flowchart illustrating the details of the file sharing process in step S524 in FIG. 5A.

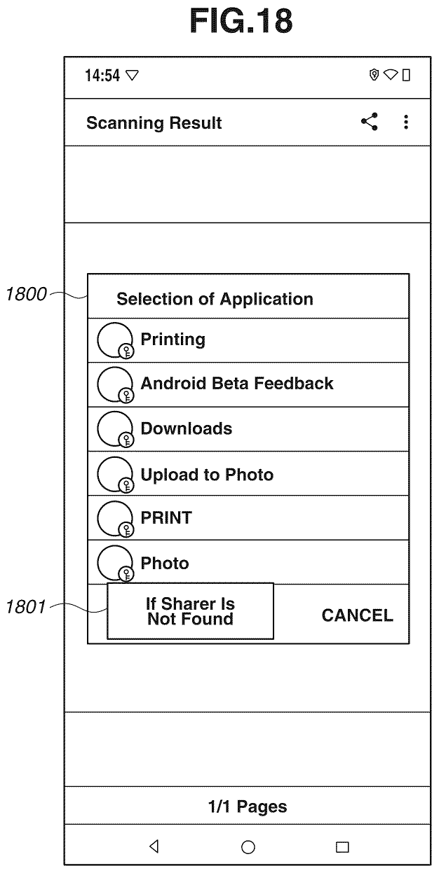

In step S1701, the CPU 201 functions as a control section and performs control to display an app selection screen 1800 (except for a display item 1801) in FIG. 18 on the display section 207. The app selection screen 1800 (an app selection screen 1) is an other app selection screen unique to the print app. That is, the app selection screen 1800 is a selection screen for another app (an app other than the print app) not as the function of the OS but as the function of the print app. The display item 1801 is not displayed in step S1701.

If the print app is started in the private space 330, the app selection screen 1800 is a selection screen for selecting an app as a sharer that shares the scanned image (the content), and is a selection screen that displays apps installed in the private space 330 as options and does not display apps installed in the personal space 320 as options.

If the print app is started in the personal space 320, the app selection screen 1800 is a selection screen for selecting an app as a sharer that shares the scanned image (the content), and is a selection screen that displays apps installed in the personal space 320 as options and does not display apps installed in the private space 330 as options.

In step S1702, the CPU 201 determines whether the print app is started in the private space (PrS) 330. The determination method in step S1702 is similar to the determination method in step S504 in FIG. 5A. If the print app is started in the private space 330 (Yes in step S1702), the processing proceeds to step S1703. If the print app is started in the personal space 320 (No in step S1702), the processing proceeds to step S1704.

In step S1703, the CPU 201 functions as a control section and performs control to display the display item 1801 (an other space guide button) on the app selection screen 1800 as illustrated in FIG. 18. The display item 1801 is a display item for displaying a guide “if sharer is not found”. That is, the display item 1801 is a display item for displaying a guide in a case where there is not a desired other app that the user wishes to select as a sharer. The display item 1801 is a button on which a touch operation can be performed, but the display item 1801 itself may be a guide. That is, the display item 1801 is a display item for displaying a guide regarding the selection of an application program that is not associated with the private space 330 as a sharer.

The CPU 201 can perform control to display in the display item 1801 a display content regarding a case where an app as a sharer that the user wishes to select is not displayed on the app selection screen 1800, or a case where the user wishes to display an app as a sharer as another selection candidate. Then, the processing proceeds to step S1704.

If it is determined in step S1702 that the print app is started in the personal space 320, the CPU 201 performs control not to display the display item 1801 in FIG. 18.

In step S1704, the CPU 201 determines whether the display item 1801 (the other space guide button) in FIG. 18 is subjected to a touch operation (selected) by a user operation on the touch panel 210. If the display item 1801 is subjected to a touch operation (Yes in step S1704), the processing proceeds to step S1705. If the display item 1801 is not subjected to a touch operation (No in step S1704), the processing proceeds to step S1715.

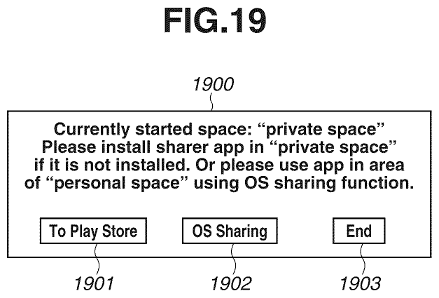

In step S1705, the CPU 201 performs control to display a guide 1900 (an other space guide) in FIG. 19 on the display section 207. The guide 1900 includes an app store button 1901, an “OS sharing” button 1902, and an “end” button 1903.

A message ‘please install sharer app in “private space” if it is not installed’ included in the guide 1900 is a guide message that urges the user to install an app desired by the user as a sharer in the private space 330 if the app is not installed. The app store button 1901 is a display item that receives an operation for installing an app desired by the user as a sharer in the private space 330 if the app is not installed. In other words, the app store button 1901 is a display item that receives an instruction to display a store screen for selecting application software that is to be installed in association with the private space 330. The app store button 1901 only needs to be a display item regarding the installation of a desired app as a sharer in the private space 330.

A message ‘please use app in area of “personal space” using OS sharing function’ included in the guide 1900 is a guide message that urges the user to select an app in the personal space 320 as a sharer using the OS sharing function 312. The “OS sharing” button 1902 is a display item that receives an operation for selecting an app in the personal space 320 using the OS sharing function 312. That is, the guide 1900 is also a guide regarding the selection of an application program associated with the personal space 320 as a sharer.

In step S1706, the CPU 201 determines whether the app store button 1901 in FIG. 19 is subjected to a touch operation by a user operation on the touch panel 210. If the app store button 1901 is subjected to a touch operation (Yes in step S1706), the processing proceeds to step S1707. If the app store button 1901 is not subjected to a touch operation (No in step S1706), the processing proceeds to step S1709.

In step S1707, the CPU 201 starts a store app regarding the private space 330 for installing an app as a sharer in the private space 330 and displays a store screen (a selection screen for one or more apps as candidates to be downloaded and installed). The user searches for a desired app that the user wishes to set as a sharer using the store app, and thereby can install the desired app in the private space 330.

In step S1708, the CPU 201 notifies an installed app of a scanned image file, also starts the installed app in cooperation, and processes the image file using the app. For example, the CPU 201 installs an online photo storage app using the store app and shares the image obtained by the scanning, and thereby can save (upload) the image obtained by the scanning in online photo storage. For example, the CPU 201 installs a social networking service (SNS) app using the store app and shares the image obtained by the scanning, and thereby can post the image obtained by the scanning to an SNS.

After the app is installed, there is a possibility that the CPU 201 cannot return to the print app. Thus, the CPU 201 may display a guide such as “please start print app again after installation.” before the store app is started. The CPU 201 saves information for identifying the file of the image as the sharing target. Then, the processing of the flowchart in FIG. 17 ends.

In step S1709, the CPU 201 determines whether the “OS sharing” button 1902 in FIG. 19 is subjected to a touch operation by a user operation on the touch panel 210. If the “OS sharing” button 1902 is subjected to a touch operation (Yes in step S1709), the processing proceeds to step S1710. If the “OS sharing” button 1902 is not subjected to a touch operation (No in step S1709), the processing proceeds to step S1714.

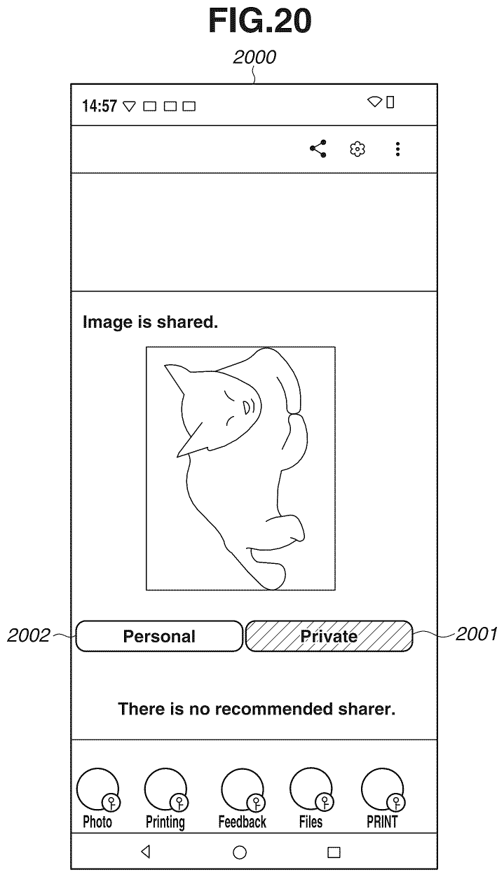

In step S1710, the CPU 201 performs control to display an app selection screen 2000 (an app selection screen 2) in FIG. 20 on the display section 207 using the sharing function of the OS. The app selection screen 2000 includes a private space button 2001 and a personal space button 2002.

If the print app is started in the private space 330, the private space button 2001 is in a selected state. In the state where the private space button 2001 is selected, the CPU 201 performs control to display on the display section 207 the app selection screen 2000 that allows the selection of an app installed in the private space 330.

The app selection screen 2000 in FIG. 20 is different from the app selection screen 1800 in FIG. 18 in step S1701 in at least one of the display order of options for an app and selectable options. The reason why in the file sharing process in FIG. 17, not the app selection screen 2000 (the app selection screen 2) using the sharing function provided by the OS, but the app selection screen 1800 (the app selection screen 1) unique to the print app is displayed first is as follows. On the app selection screen 2, the print app cannot take part in (determine) the display order (the arrangement order) of apps as options and whether to display apps as options. That is, there is a case where an app that is normally not assumed to be selected as a sharer by the print app is earlier in the display order, and an app frequently selected as a sharer by the print app is later in the display order. As a result, an operation until the selection of an app frequently selected by the user becomes cumbersome, which is user-unfriendly. In contrast, on the app selection screen 1, the print app can determine the display order (the arrangement order) of apps as options and whether to display apps as options. Thus, it is possible to reflect the intention of the manufacturer of the print app, such as the prior display of an app frequently selected as a sharer by the print app and the provision of a function that is convenient if the function is specified as a sharer by the print app. This can improve user-friendliness for the user.

In step S1711, the CPU 201 determines whether the private space button 2001 or the personal space button 2002 in FIG. 20 is subjected to a touch operation by a user operation on the touch panel 210. If the private space button 2001 or the personal space button 2002 is subjected to a touch operation (Yes in step S1711), the processing returns to step S1710 via step S1712. If the private space button 2001 or the personal space button 2002 is not subjected to a touch operation (No in step S1711), the processing proceeds to step S1713.

In steps S1712 and S1710, if the personal space button 2002 is subjected to a touch operation, the CPU 201 brings the personal space button 2002 into a selected state and performs control to display on the display section 207 the app selection screen 2000 that allows the selection of an app installed in the personal space 320.

If the private space button 2001 is subjected to a touch operation, the CPU 201 brings the private space button 2001 into the selected state and performs control to display on the display section 207 the app selection screen 2000 that allows the selection of an app installed in the private space 330.

As described above, if the sharing function provided by the OS is used, it is possible to display a screen that allows the selection of an app installed in the private space 330 and a screen that allows the selection of an app installed in the personal space 320 by switching the screens. That is, if the sharing function provided by the OS is used, it is possible to select both an app installed in the private space 330 and an app installed in the personal space 320.

In step S1713, the CPU 201 determines whether an app as a sharer is selected on the app selection screen 2000. If an app is not selected (No in step S1713), the processing returns to step S1711. If an app is selected (Yes in step S1713), the processing proceeds to step S1716.

In step S1714, the CPU 201 determines whether the “end” button 1903 in FIG. 19 is subjected to a touch operation by a user operation on the touch panel 210. If the “end” button 1903 is not subjected to a touch operation (No in step S1714), the processing returns to step S1706. If the “end” button 1903 is subjected to a touch operation (Yes in step S1714), the CPU 201 ends the display of the guide 1900 in FIG. 19, and the processing returns to step S1701.

In step S1715, the CPU 201 determines whether an app as a sharer is selected on the app selection screen 1800 in FIG. 18. If an app is not selected (No in step S1715), the processing returns to step S1704. If an app is selected (Yes in step S1715), the processing proceeds to step S1716.

In step S1716, the CPU 201 notifies the selected app of a scanned image file, also starts the selected app as a sharer app in cooperation, and processes the image file using the app (the sharer app). Then, the processing of the flowchart in FIG. 17 ends.

Although a description has been given using as an example a case where in steps S1702 and S1703, if the print app is started in the private space 330, the CPU 201 displays the display item 1801 in FIG. 18, the present disclosure is not limited to this. Also if the print app is started in the personal space 320, the CPU 201 may perform control to display the display item 1801. In this case, if the display item 1801 is subjected to a touch operation, the processing proceeds to step S1705. In step S1705, the CPU 201 performs control to display the guide 1900 in FIG. 19.

If the app store button 1901 in FIG. 19 is subjected to a touch operation, then in step S1707, the CPU 201 starts a store app for installing an app as a sharer in the personal space 320 if the print app is started in the personal space 320.

If the “OS sharing” button 1902 in FIG. 19 is subjected to a touch operation, then in step S1710, the CPU 201 performs control to display the app selection screen 2000 in FIG. 20.

As described above, according to the present exemplary embodiment, in the case of the document printing 601, if an app is started in the private space 330 or the personal space 320, there is a case where a desired content is present in a space different from the space where the app is started. Thus, it is possible to display a guide for starting the app in another space.

Based on the file sharing process in FIG. 17, it is possible to perform control to display the “OS sharing” button 1902 regarding the display of the app selection screen 2000 that allows the selection of both an app installed in the private space 330 and an app installed in the personal space 320 as illustrated in FIG. 20.

Based on step S1707 in FIG. 17, if the print app is started in the private space 330, and if a desired app as a sharer is not present in the private space 330, it is possible to start a store app for installing an app as a sharer in the private space 330.

If the print app is started in the personal space 320, and if a desired app as a sharer is not present in the personal space 320, it is possible to start a store app for installing an app as a sharer in the personal space 320.

Although in FIGS. 5A and 5B, a description has been given using the processing of a print app (a printer control app) as an example, the present disclosure is not limited to a print app, and is applicable to various apps. For example, embodiments of the present disclosure are applicable to an image viewing app (an album app), an online storage management app, an SNS app, a message app, an email app, a communication app, an image editing app, and an Internet-of-Things (IoT) device management app. The electronic device 180 is not limited to a smartphone, and is applicable to an electronic device such as a tablet, a personal computer, a smartwatch, a game apparatus, a television, a set-top box, or a moving image reproduction apparatus that is capable of operating by installing an app.

The above various types of control performed by the CPU 201 in the description may be performed by a single piece of hardware, or the processing of the above various types of control may be shared by a plurality of pieces of hardware (e.g., a plurality of processors or circuits), thereby controlling the entirety of the apparatus.

While the present disclosure has been described in detail based on its suitable exemplary embodiments, the present disclosure is not limited to these specific exemplary embodiments, and is also applicable to various forms without departing from the spirit and scope of the disclosure. Further, the above exemplary embodiments merely illustrate exemplary embodiments of the present disclosure, and can also be appropriately combined together.

In the above exemplary embodiments, a description has been given using as an example a case where embodiments of the present disclosure are applied to a smartphone. The present disclosure, however, is not limited to this example, and is applicable to any electronic device 180 capable of operating by installing an app. That is, the present disclosure is applicable to a personal computer, a personal digital assistant (PDA), a mobile phone terminal, a mobile image viewer, a music player, a game apparatus, or an electronic book reader.

According to embodiments of the present disclosure, in a mechanism for managing an app and a content in association with any of a plurality of spaces, a user is enabled to operate the app and the content more suitably.

Other Embodiments Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139986, filed Aug. 21, 2024, which is hereby incorporated by reference herein in its entirety.

What is claimed is:

1. A non-transitory computer-readable storage medium storing an application program including instructions, which when executed by one or more processors of an electronic device, in which each of a plurality of pieces of application software is managed in association with any of a plurality of spaces including a first space where a lock needs to be unlocked and a second space where the lock does not need to be unlocked, cause the electronic device to:
in a case where the application program is associated with the first space, perform control to display a first screen for selecting a content saved in association with the first space; and
in a case where the application program is associated with the first space, perform control to display on the first screen a first display item for displaying a guide regarding start of an application program associated with the second space.

2. A non-transitory computer-readable storage medium storing an application program including instructions, which when executed by one or more processors of an electronic device, in which each of a plurality of pieces of application software is managed in association with any of a plurality of spaces including a first space where a lock needs to be unlocked and a second space where the lock does not need to be unlocked, cause the electronic device to:
in a case where the application program is associated with the first space, perform control to display a first screen for selecting a content saved in association with the first space; and
perform control to display on the first screen a first display item for displaying a guide regarding switching of the first screen so that a content saved in association with the second space is a selection target.

3. The non-transitory computer-readable storage medium according to claim 2, wherein the instructions, when executed by the one or more processors, cause the electronic device to, in a case where the application program is associated with the second space, perform control not to display, on a second screen for selecting a content saved in association with the second space, a display item for displaying a guide regarding switching of the second screen so that a content saved in association with the first space is a selection target.

4. The non-transitory computer-readable storage medium according to claim 2, wherein the instructions, when executed by the one or more processors, cause the electronic device to, in a case where the application program is associated with the second space, perform control to display, on a second screen for selecting a content saved in association with the second space, a display item for displaying a guide regarding switching of the second screen so that a content saved in association with the first space is a selection target.

5. The non-transitory computer-readable storage medium according to claim 2, wherein the instructions, when executed by the one or more processors, further cause the electronic device to transmit a print job regarding a content selected on the first screen.

6. The non-transitory computer-readable storage medium according to claim 2, wherein each of the contents is a document file.

7. A non-transitory computer-readable storage medium storing an application program including instructions, which when executed by one or more processors of an electronic device, in which each of a plurality of pieces of application software is managed in association with any of a plurality of spaces including a first space where a lock needs to be unlocked and a second space where the lock does not need to be unlocked, cause the electronic device to:
in a case where the application program is associated with the first space, perform control to display a first screen that is a screen for selecting application software as a sharer that shares a content, does not display application software associated with the second space as an option, and displays one or more pieces of application software associated with the first space as options; and
perform control to display on the first screen a first display item for displaying a guide regarding selection of application software that is not associated with the first space as the sharer.

8. The non-transitory computer-readable storage medium according to claim 7, wherein the instructions, when executed by the one or more processors, cause the electronic device to, in a case where the application program is associated with the second space, perform control not to display, on a second screen that is a screen for selecting application software as a sharer that shares a content, does not display application software associated with the first space as an option, and displays one or more pieces of application software associated with the second space as options, a display item for displaying a guide regarding selection of application software that is not associated with the second space as the sharer.

9. The non-transitory computer-readable storage medium according to claim 7, wherein the instructions, when executed by the one or more processors, cause the electronic device to, in a case where the application program is associated with the second space, perform control to display, on a second screen that is a screen for selecting application software as a sharer that shares a content, does not display application software associated with the first space as an option, and displays one or more pieces of application software associated with the second space as options, a display item for displaying a guide regarding selection of application software that is not associated with the second space as the sharer.

10. The non-transitory computer-readable storage medium according to claim 7, wherein the guide is a guide regarding selection of application software associated with the second space as the sharer.

11. The non-transitory computer-readable storage medium according to claim 10,
wherein the first screen is not a sharing screen using a function of an operating system (OS), but a screen displayed as a function of the application program, and
wherein the guide is a guide regarding display of the sharing screen using the function of the OS that enables switching with which space application software to be an option is associated.

12. The non-transitory computer-readable storage medium according to claim 11, wherein the guide includes a second display item that receives an instruction to display the sharing screen using the function of the OS, and the sharing screen using the function of the OS is displayed according to an operation on the second display item.

13. The non-transitory computer-readable storage medium according to claim 7, wherein the guide is a guide regarding installation of application software that is to be a sharer in association with the first space.

14. The non-transitory computer-readable storage medium according to claim 13, wherein the guide includes a third display item that receives an instruction to display a store screen for application software, and a store screen for selecting application software that is to be installed in association with the first space is displayed according to an operation on the third display item.

15. The non-transitory computer-readable storage medium according to claim 7, wherein the content is a scanned image.

16. The non-transitory computer-readable storage medium according to claim 15, wherein the instructions, when executed by the one or more processors, cause the electronic device to perform control to display the first screen for selecting application software as a sharer in a case where an image scanned based on a scan job transmitted from the electronic device to a scanner is shared.

17. The non-transitory computer-readable storage medium according to claim 2, wherein the instructions, when executed by the one or more processors, cause the electronic device to, in a case where a storage location referred to in a case where the first screen is displayed satisfies a predetermined condition, determine that the application program is associated with the first space.

18. The non-transitory computer-readable storage medium according to claim 2, wherein the instructions, when executed by the one or more processors, cause the electronic device to perform control to display the guide in the first display item.

19. The non-transitory computer-readable storage medium according to claim 2, wherein the instructions, when executed by the one or more processors, cause the electronic device to perform control to display the guide in a case where the first display item is operated.

20. The non-transitory computer-readable storage medium according to claim 2,
wherein the electronic device can be used by unlocking a first lock, and
wherein the first space requires unlocking of a second lock different from the unlocking of the first lock in at least one of a timing and a lock unlocking key.

21. The non-transitory computer-readable storage medium according to claim 20, wherein in a case where the second lock is not unlocked, an application program associated with the first space is hidden in the most recent view, a notification, a setting, and another application program.

22. The non-transitory computer-readable storage medium according to claim 2, wherein the first and second spaces are different from each other in a root directory of a save destination of a content and application software.

23. The non-transitory computer-readable storage medium according to claim 2, wherein in a case where the application program is to be used in each of the first and second spaces, the application program needs to be installed in each of the first and second spaces even in a case where the application program is the same application program, except for an OS standard function.

24. The non-transitory computer-readable storage medium according to claim 2, wherein a startup icon for an application program associated with the first space and a startup icon for an application program associated with the second space are displayed in display areas of the electronic device different from each other even in a case where the application programs are the same application program.

25. The non-transitory computer-readable storage medium according to claim 2, wherein application software and a content in the second space cannot be moved to the first space by a user operation.

26. A control method regarding an application program for an electronic device, in which each of a plurality of pieces of application software is managed in association with any of a plurality of spaces including a first space where a lock needs to be unlocked and a second space where the lock does not need to be unlocked, the control method comprising:
in a case where the application program is associated with the first space, performing control to display a first screen for selecting a content saved in association with the first space; and
in a case where the application program is associated with the first space, performing control to display on the first screen a first display item for displaying a guide regarding start of an application program associated with the second space.

27. A control method regarding an application program for an electronic device, in which each of a plurality of pieces of application software is managed in association with any of a plurality of spaces including a first space where a lock needs to be unlocked and a second space where the lock does not need to be unlocked, the control method comprising:
in a case where the application program is associated with the first space, performing control to display a first screen for selecting a content saved in association with the first space; and
performing control to display on the first screen a first display item for displaying a guide regarding switching of the first screen so that a content saved in association with the second space is a selection target.

28. A control method regarding an application program for an electronic device, in which each of a plurality of pieces of application software is managed in association with any of a plurality of spaces including a first space where a lock needs to be unlocked and a second space where the lock does not need to be unlocked, the control method comprising:
in a case where the application program is associated with the first space, performing control to display a first screen that is a screen for selecting application software as a sharer that shares a content, does not display application software associated with the second space as an option, and displays one or more pieces of application software associated with the first space as options; and
performing control to display on the first screen a first display item for displaying a guide regarding selection of application software that is not associated with the first space as the sharer.

29. An electronic device, in which each of a plurality of pieces of application software is managed in association with any of a plurality of spaces including a first space where a lock needs to be unlocked and a second space where the lock does not need to be unlocked, the electronic device comprising:
at least one memory and at least one processor which function as:
a first control unit configured to, in a case where an application program that operates on the electronic device is associated with the first space, perform control to display a first screen for selecting a content saved in association with the first space; and
a second control unit configured to, in a case where the application program is associated with the first space, perform control to display on the first screen a first display item for displaying a guide regarding start of an application program associated with the second space.

30. An electronic device, in which each of a plurality of pieces of application software is managed in association with any of a plurality of spaces including a first space where a lock needs to be unlocked and a second space where the lock does not need to be unlocked, the electronic device comprising:
at least one memory and at least one processor which function as:
a first control unit configured to, in a case where an application program that operates on the electronic device is associated with the first space, perform control to display a first screen for selecting a content saved in association with the first space; and
a second control unit configured to perform control to display on the first screen a first display item for displaying a guide regarding switching of the first screen so that a content saved in association with the second space is a selection target.

31. An electronic device, in which each of a plurality of pieces of application software is managed in association with any of a plurality of spaces including a first space where a lock needs to be unlocked and a second space where the lock does not need to be unlocked, the electronic device comprising:
at least one memory and at least one processor which function as:
a first control unit configured to, in a case where an application program that operates on the electronic device is associated with the first space, perform control to display a first screen that is a screen for selecting application software as a sharer that shares a content, does not display application software associated with the second space as an option, and displays one or more pieces of application software associated with the first space as options; and
a second control unit configured to perform control to display on the first screen a first display item for displaying a guide regarding selection of application software that is not associated with the first space as the sharer.
